(19) United States
(12) Patent Application Publication
(10) Pub. No.: US 2002/0198767 A1
(43) Pub. Date: Dec. 26, 2002

(54) Fee collecting system and method for motor vehicle

(76) Inventor: Kwang-Duck Kim, Bupyeong-ku (KR)

Correspondence Address: BAKER BOTTS L.L.P., 2001 ROSS AVENUE, SUITE 600, DALLAS, TX, 75201-2980, US

(21) Appl. No.: 09/997,833

(22) Filed: Nov. 29, 2001

(30) Foreign Application Priority Data
Aug. 31, 2001 (KR) 10-2001-53636
Aug. 31, 2001 (KR) 10-2001-53637
Jun. 22, 2001 (KR) 20-2001-18848

(51) Int. Cl. G06F 17/60

(52) U.S. Cl. 705/13

(57) ABSTRACT

A fee collecting system for motor vehicles is disclosed. The fee collecting system includes a plurality of collecting systems that transmit payment request signals to a motor vehicle and receive response signals to payment requests from the motor vehicle, a motor vehicle control device mounted in the motor vehicle that transmits a telephone number and the information of the motor vehicle when the payment request signal is detected, a central system that receives and records information from the collecting systems and calculates charges when the motor vehicle leaves, and a payment system that settles the payment of the charges and notifies it to the central system. The present invention can automatically detect the entrance and departure of a motor vehicle and make charges through a mobile phone number mounted in the vehicle, and notify the driver of a process result of the charges of the motor vehicle through a mobile phone number mounted in the vehicle. Additionally, the present invention can save resources because a secondhand mobile phone is used as a car phone by being connected with the motor vehicle control device.

### BACKGROUND OF THE INVENTION

1. Field of the Invention

The present invention relates to fee collecting, and more particularly, to a fee collecting system and method for motor vehicles capable of detecting a motor vehicle through a motor vehicle control device provided to the vehicle and automatically making parking fee or toll based on the detected information of the vehicle.

2. Background of the Related Art

With the spread of motor vehicles, various fees in relation to the driving of a motor vehicle have increased in number. Such charges in relation to the driving of the motor vehicle include a parking fee for the use of a parking lot and a toll for the use of an expressway.

First, in the case of the parking lot, a driver receives a card, in which an entrance time is indicated when the motor vehicle enters the parking lot, and pays a charge when the motor vehicle leaves the parking lot. The parking fee corresponds to the period of time spent in the parking lot which is calculated by subtracting the entrance from the time that the motor vehicle leaves the parking lot. At this time, the driver generally pays the parking charge in cash.

Meanwhile, in the case of an expressway, the driver receives an entrance ticket when the motor vehicle enters a tollgate and pays a toll when the motor vehicle leaves through another tollgate. At this time, the toll is a charge that corresponds to the distance between the entry tollgate and a freeway exit. The driver can pay the toll in cash or use a passage card, in which a prescribed amount of money is saved up.

However, such conventional methods for paying charges have the following several problems.

First, the driver must keep the entrance ticket or parking ticket received when the motor vehicle enters the expressway or the parking lot without loss. Furthermore, because such entrance tickets or parking tickets have magnetic strips, in which the information of the entrance time and the tollgate is recorded, the driver must keep it until the motor vehicle leaves the freeway exit or the parking lot without any damage.

Second, there is the problem of the incorrect operation of the motor vehicle due to the driver's motions when the driver receives the entrance ticket. Moreover, it takes a long time to receive the entrance ticket if there is a distance between the driver and the entrance ticket dispenser, thereby slowing traffic.

Third, it takes a long time to take out cash and pay the fee in cash or with a passage card after stopping the motor vehicle at a tollgate. The motor vehicle may be operated incorrectly due to the driver's motions during the payment of the fee. Furthermore, because it takes so long to pay the fee, it may cause traffic problems in the vicinity of the tollgate.

Meanwhile, with the development of mobile communication technology, new models of mobile communication terminals have been released every year. As the rate of mobile communication improves, older mobile communication terminals still having various functions are treated like secondhand goods. Therefore, there arises a need to prevent such waste of resources by utilizing the secondhand terminals properly.

### SUMMARY OF THE INVENTION

Accordingly, the present invention is directed to a fee collecting system and method for motor vehicles that substantially obviate one or more problems due to present limitations and disadvantages of the related art.

An object of the present invention is to provide a fee collecting system for motor vehicles capable of automatically detecting entrance and departure of a motor vehicle and making charges through a mobile phone number mounted in the vehicle.

Another object of the present invention is to provide a fee collecting system for motor vehicles capable of notifying the driver of a process result of the charges of the motor vehicle through a mobile phone number mounted in the vehicle.

A further object of the present invention is to provide a motor vehicle control device capable of transmitting the information of a motor vehicle to a receiving part to settle the payment of the charges when a prescribed payment request signal is received.

A still further object of the present invention is to provide a fee collecting method for motor vehicles capable of automatically making a parking fee by collecting the information of a vehicle as it enters and leaves a parking lot.

A still further object of the present invention is to provide a fee collecting method for motor vehicles capable of automatically making a toll by collecting the information of a vehicle as it enters and leaves an expressway.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a fee collecting system for motor vehicles, which detects the entrance and departure of the motor vehicle and makes charges, includes: a plurality of collecting systems transmitting payment request signals to a detected motor vehicle when the motor vehicle is detected, each collecting system outputting response signals to the payment request, an ID number and time information when the response signal of the payment request is received from the motor vehicle; a motor vehicle control device mounted in the motor vehicle, the motor vehicle control device transmitting a telephone number and response signal of payment request with the information of the motor vehicle when the payment request signal is detected from the collecting system; a central system receiving and recording the response signal of payment request, the ID number and the time information output from the collecting system, the central system calculating charges based on the recorded information when the motor vehicle goes out and requesting settlement of the payment; and a payment system settling the payment of the charges when the payment is requested from the central system and notifying it to the central system.

It is preferable that the central system determines whether the motor vehicle enters or leaves based on the ID number.

It is preferable that the central system totals all charges in all areas among the collecting systems if the collecting systems are installed in a motor vehicle traveling through several areas.

It is preferable that the central system calculates the charges based on a period of time between an entrance time and a departure time of the motor vehicle if the collecting systems are installed in a parking area.

It is preferable that the collecting system has a payment request signal sending/receiving part.

It is preferable that the motor vehicle control device includes: a payment request signal sending/receiving part for receiving payment request signals from the collecting system and sending response signals to payment requests; a motor vehicle information storage for storing a user's mobile phone number, number of motor vehicle and kind of motor vehicle; a controller extracting the mobile phone number, the number of motor vehicle and the kind of motor vehicle stored in the motor vehicle information storage when the payment request signal is detected from the payment request signal sending/receiving part and transmitting them to the payment requesting signal sending/receiving part; and an interface for transmitting data and control signal between the controller and the mobile terminal to the controller and the mobile terminal according to a designated protocol.

It is preferable that the motor vehicle control device includes: a display for displaying the status of a payment request and a process result on a screen; and a sound output part for outputting the status of the payment request and the process result in sound.

It is preferable that the motor vehicle control device includes: a key input part for inputting an order to refer the status of the payment request and the process result; and a sound input part for inputting a voice order to refer the status of the payment request and the process result.

In another aspect of the present invention, a motor vehicle control device includes: a payment request signal sending/receiving part for receiving payment request signals and sending response signals to payment request; a motor vehicle information storage for storing a user's mobile phone number, number of motor vehicle and kind of motor vehicle; a controller extracting the mobile phone number, the number of motor vehicle and the kind of motor vehicle stored in the motor vehicle information storage when the payment request signal is detected by the payment request signal sending/receiving part and transmitting them to the payment request signal sending/receiving part; and an interface for transmitting data and control signals between the controller and the mobile terminal to the controller and the mobile terminal according to a designated protocol.

It is preferable that the motor vehicle control device further includes: a display for displaying the status of the payment request and a process result on a screen; and a sound output part for outputting the status of the payment request and the process result in sound.

It is preferable that the motor vehicle control device further includes: a key input part for inputting an order to refer to the status of the payment request and the process result; and a voice input part for inputting a sound order to refer to the status of the payment request and the process result.

In a further aspect of the present invention, a fee collecting method for motor vehicles includes: receiving the information of an entering motor vehicle from the entering motor vehicle when the entering motor vehicle is detected; storing the information of the entering motor vehicle received from the entering motor vehicle; receiving information of a departing motor vehicle from the going-out motor vehicle when the departing motor vehicle is detected; storing the information of the departing motor vehicle received from the going-out motor vehicle; extracting the information of the entering motor vehicle corresponding to the information of the departing motor vehicle when the storing of the information of the departing motor vehicle is completed; calculating a charge based on the information of the entering motor vehicle and the information of the departing motor vehicle; and requesting a payment of the charge calculated in the calculating step.

It is preferable that the information of the entering motor vehicle received in the step of receiving the information of the entering motor vehicle includes a telephone number of a mobile terminal, the number of the motor vehicle and the kind of the motor vehicle.

It is preferable that the step of storing the information of the entering motor vehicle includes a step of storing the time of receiving the information of the entering motor vehicle.

It is preferable that in the step of receiving the information of the departing motor vehicle, the information of the departing motor vehicle includes a telephone number of a mobile terminal, the number of the motor vehicle and the kind of motor vehicle.

It is preferable that the step of storing the information of the departing motor vehicle includes a step of storing the time of receiving the information of the departing motor vehicle.

It is preferable that the step of calculating the charge includes a step of calculating a value, that the time of receiving the information of the entering motor vehicle be subtracted from the time of receiving the information of the departing motor vehicle, as the charge.

It is preferable that the step of requesting the payment includes a step of sending a request of payment to the mobile communication service company of the telephone number of the mobile terminal included in the information of the motor vehicle.

In a still further aspect of the present invention, a fee collecting method for motor vehicles includes: receiving the information of an entering motor vehicle from the entering motor vehicle when the entering motor vehicle is detected; storing the information of the entering motor vehicle received from the entering motor vehicle; receiving the information of a moving motor vehicle from the moving motor vehicle when the moving motor vehicle is detected; storing the information of the moving motor vehicle received from the moving motor vehicle; receiving the information of a departing motor vehicle from the departing motor vehicle when the departing motor vehicle is detected; storing the information of the departing motor vehicle received from the departing motor vehicle; extracting the information of the entering motor vehicle and the moving motor vehicle corresponding to the information of the departing motor vehicle when the storing of the information of the departing motor vehicle is completed; calculating a charge based on the information of the entering motor vehicle, the information of the departing motor vehicle and the information of the moving motor vehicle; and requesting a payment of the charge calculated in the calculating step.

It is preferable that in the information of the entering motor vehicle received in the step of receiving the information of the entering motor vehicle, the information of the entering motor vehicle includes a telephone number of a mobile terminal, the number of the motor vehicle and the kind of motor vehicle.

It is preferable that the step of storing the information of the entering motor vehicle includes a step of storing an identifier of the device detecting the entering motor vehicle and the time of receiving the information of the entering motor vehicle.

It is preferable that in the step of receiving the information of the moving motor vehicle, the information of the moving motor vehicle includes a telephone number of a mobile terminal, the number of the motor vehicle and the kind of motor vehicle.

It is preferable that the step of storing the information of the moving motor vehicle includes a step of an identifier of the device detecting the moving motor vehicle and the time of receiving the information of the moving motor vehicle.

It is preferable that in the step of receiving the information of the departing motor vehicle, the information of the departing motor vehicle includes the telephone number of a mobile terminal, the number of the motor vehicle and the kind of motor vehicle.

It is preferable that the step of storing the information of the departing motor vehicle includes a step of an identifier of the device detecting the departing motor vehicle and time receiving the information of the departing motor vehicle.

It is preferable that the step of calculating the charge includes a step of calculating a value between areas of the identifiers of the devices, which detect the motor vehicle, based on the information of the entering motor vehicle, the information of the moving motor vehicle and the information of the departing motor vehicle as the charge.

It is preferable that the step of requesting the payment includes a step of sending a request of the payment to the mobile communication service company of the telephone number of the mobile terminal included in the information of the motor vehicle.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a general view of a structure of a fee collecting system for motor vehicle according to the present invention;

FIG. 2 illustrates a view showing a connection state between a motor vehicle control device and a mobile terminal provided to the vehicle shown in FIG. 1;

FIG. 3 illustrates a flow chart of an operation of a controller of the motor vehicle control device provided to the vehicle shown in FIG. 2;

FIGS. 4A to 4B illustrates a flow chart showing an operation of a central system of FIG. 1 in detail;

FIG. 5 illustrates a flow chart showing a fee collecting method for motor vehicles in a parking lot in detail according to another embodiment of the present invention; and

FIG. 6 illustrates a flow chart showing a fee collecting method for motor vehicle on an expressway in detail according to a further embodiment of the present invention.

### DETAILED DESCRIPTION OF THE INVENTION

Reference will now be made in detail to the preferred embodiments of the present invention, examples of which are illustrated in the accompanying drawings.

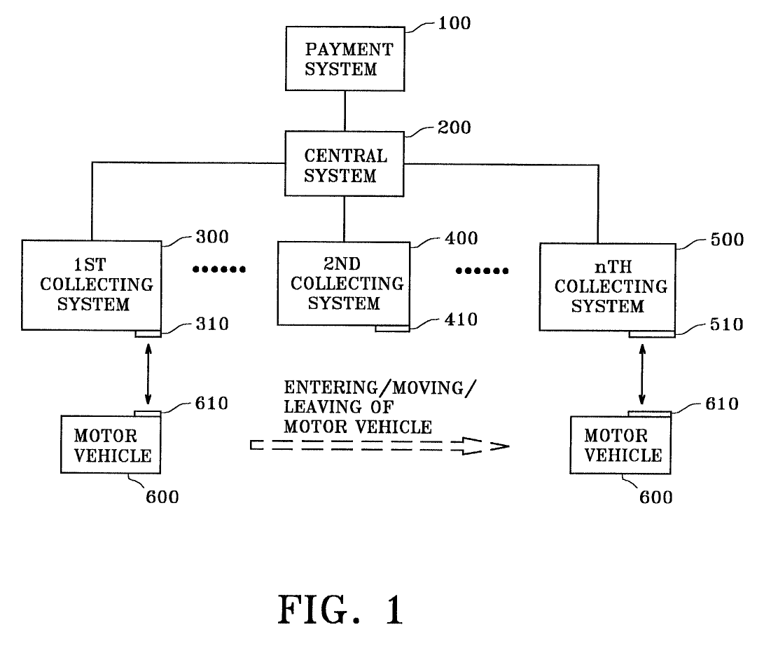

FIG. 1 illustrates a general view of a structure of a fee collecting system for motor vehicle according to the present invention. In FIG. 1, the reference numeral 100 designates a payment system, 200 a central system, 300 to 500 collecting systems, and 600 a motor vehicle.

As shown in FIG. 1, the first collecting system 300, the second collecting system 400 and the final collecting system 500 are connected to the central system 200. For example, in the case where the fee collecting system according to a preferred embodiment of the present invention is applied to fee collecting on an expressway, the first through final collecting systems 300 to 500 are installed at each tollgate of the expressway, and each collecting system is connected to the central system 200 to transmit data.

Then, the collecting systems 300 to 500 communicate with a payment request signal sending/receiving part 610, which is mounted in the vehicle 600, through a payment request signal sending/receiving part 610, which is mounted in the collecting system 310, thereby collecting the information of the motor vehicle, such as the mobile phone number of the motor vehicle, the license number of the vehicle, the kind of vehicle, and so on.

At this time, each collecting system transmits the information of the motor vehicle, detected the time and information of the number of the collecting system. Then, the central system 200 stores the information received from the collecting system in order, adds the charges according to a standard of charge applied to each area, and sends a request of the payment of the charges to the payment system 100.

That is, the central system 200 is connected with the payment system 100 to settle the payment of a toll on the expressway. For example, in the case where the payment system 100 imposes the toll on a bill of telephone charges of the mobile phone, the payment system 100 is a payment system of a corresponding mobile phone service company. The payment system 100 may be connected with a collecting system of a credit card service company according to business affairs of the operator.

Meanwhile, in the case of a parking lot, the first collecting system 300 is installed at a place that the motor vehicle enters and the final collecting system 500 is installed at a place that the motor vehicle leaves the parking lot. Therefore, in the case where the motor vehicle enters the parking lot, the first collecting system 300 transmits the information of the entering motor vehicle and the information of the entrance time to the central system 200. In the case where the motor vehicle leaves the parking lot, the final collecting system 500 transmits information of the departing motor vehicle and information of the departure time to the central system 200. At this time, the central system 200 calculates the parking charge based on the entrance time and the departing time of the corresponding motor vehicle and sends a request of the payment of the charge to the payment system 100.

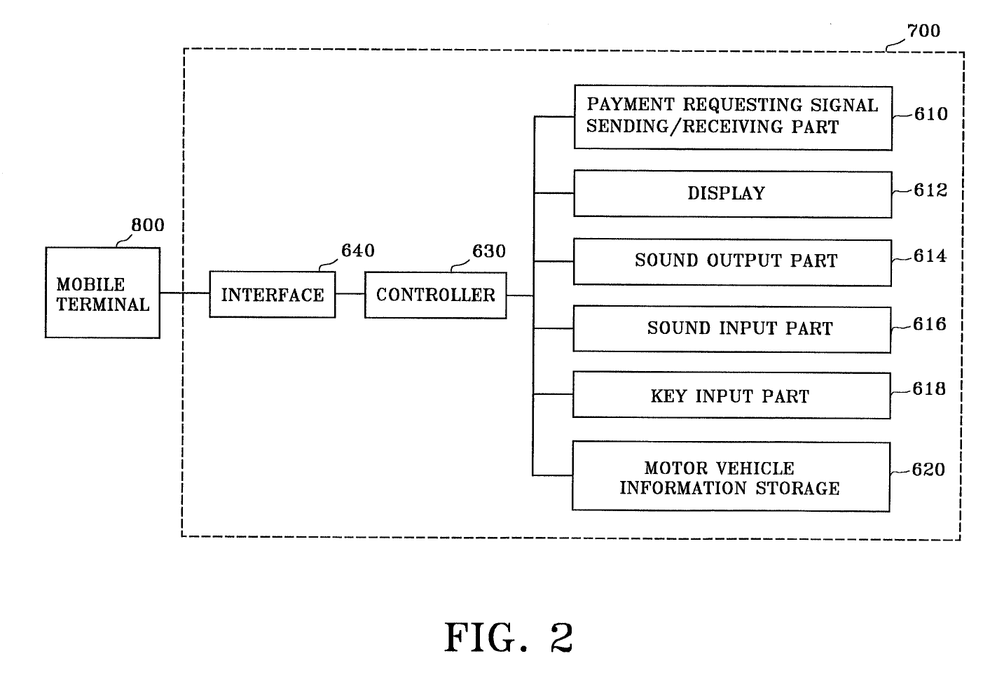

FIG. 2 illustrates a view showing a connection state between a motor vehicle control device and a mobile terminal provided to the vehicle shown in FIG. 1. In FIG. 2, the reference numeral 610 designates the payment request signal sending/receiving part, 612 a display, 614 a sound output part, 616 a sound input part, 618 a key input part, 620 a motor vehicle information storage, 630 a controller, 640 an interface, and 800 a mobile terminal. The reference numeral 700 designates a motor vehicle control device.

The controller 630 is connected to the payment request signal sending/receiving part 610, the display 612, the sound output part 614, the sound input part 616, the key input part 618 and the motor vehicle information storage 620 and controls them to respond to the payment request from the collecting system. The controller 630 is connected with the mobile terminal 800 through the interface 640.

The payment request signal sending/receiving part 610 is, for example, installed on the outside of the motor vehicle and sends/receives payment request signals to/from the collecting system. The display 612 includes, for example, an LCD panel to display data from the controller 630 or the mobile terminal 800. The key input part 618 consists of, for example, a keypad and performs a selective input requested from the controller 630 or inputs a telephone number to call through the mobile terminal 800. Meanwhile, the sound output part 614 outputs the status of a payment request in sound according to the control of the controller 630 or outputs a call tone from the mobile terminal 800. The sound input part 616 allows a user to input the user's selected matters relative to the payment request in voice order according to the control of the controller 630 or inputs call tone of the mobile terminal 800.

Therefore, the display 612 is mounted in the vicinity of the gauge board of the motor vehicle to allow the driver to easily check. The key input part 618 is mounted in the vicinity of a driver's seat to allow the driver to easily input keys or dial telephone numbers. The sound output part 614 and the sound input part 616 are mounted in the vicinity of the driver's seat to make sound input and output possible.

In the drawings, the motor vehicle information storage 620 stores the phone numbers and information of the vehicle to collect the charges or receive a process result. The motor vehicle information is information indicating whether the motor vehicle is an automobile or a motor-omnibus and the license number of the motor vehicle. Such information about the motor vehicle is set and registered when the motor vehicle control device 700 is mounted on the motor vehicle.

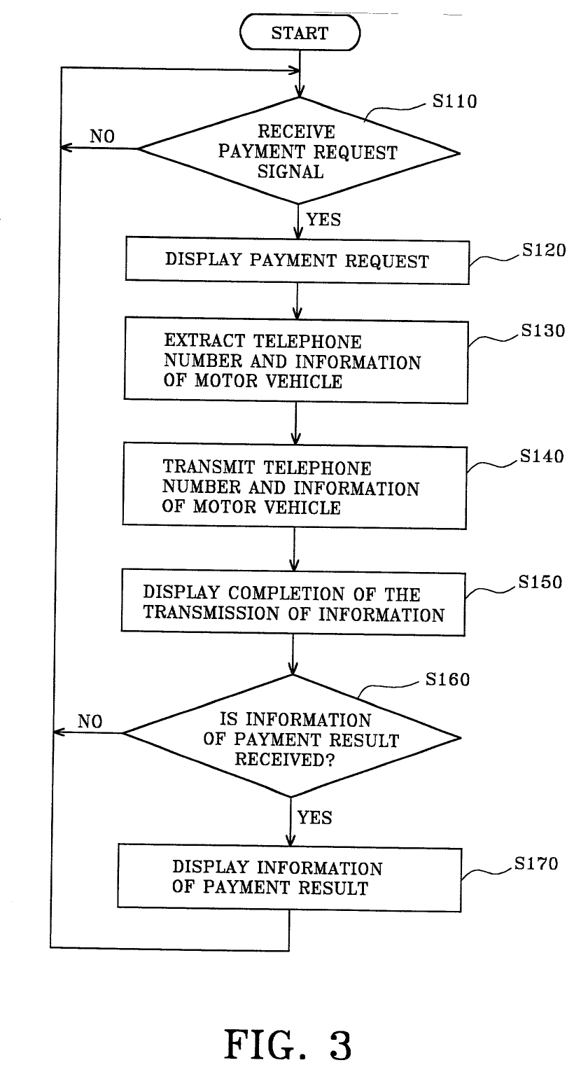

FIG. 3 illustrates a flow chart of an operation of a controller of the motor vehicle control device 700 provided to the vehicle shown in FIG. 2.

First, if the payment request signal sending/receiving part 610 mounted in the motor vehicle receives the payment signal from the collecting system (S110), the controller 63 displays a message indicating the payment request through the display 612 (S120). At this time, the controller 630 outputs the payment request through the sound output part 614 in sound.

Then, the controller 630 extracts the telephone number of the mobile terminal and the information of the motor vehicle from the motor vehicle information storage 620 (S130). The controller 630 transmits the extracted telephone number of the mobile terminal and the extracted information of the motor vehicle to the collecting system through the payment request signal sending/receiving part 610 (S140). If the transmission of information is completed, the controller 630 displays the completion of the information transmission through the display 612 or the sound output part 614(S150).

After the charge of the motor vehicle is paid based on the transmitted information, the central system 200 notifies the process result through the mobile phone. The notification of the process result is received through the mobile terminal 800, for example, an SMS (Short Message Service) or a data communication.

Then, when the controller 630 receives message of the process result through the mobile terminal 800 (S160), the controller 630 outputs the received message through the display 612 or the sound output part 614 (S170).

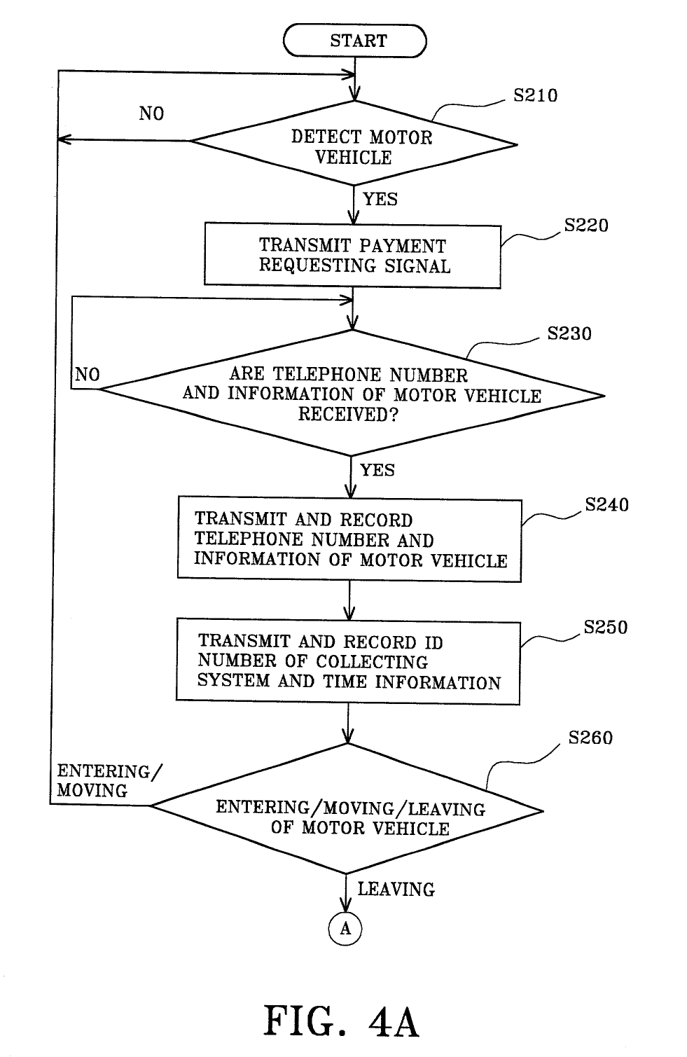

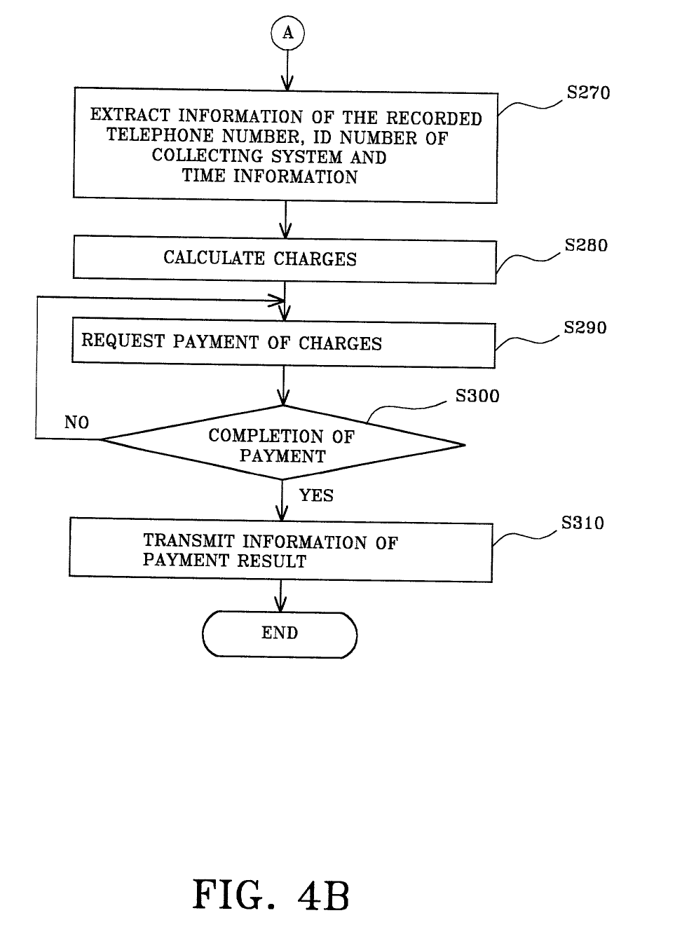

FIGS. 4A to 4B illustrates a flow chart showing an operation of a central system of FIG. 1 in detail.

First, when the motor vehicle is detected (S210), the collecting systems 300 to 500 transmits payment request signal through the payment request signal sending/receiving part 310 to 510 connected to the collecting systems (S220).

Then when the telephone number and information of the motor vehicle are received from the motor vehicle (S230), the collecting system transmits the received information to the central system 200. Furthermore, the collecting system transmits the number of the collecting system and time information to the central system 200. When the telephone number, the information of the motor vehicle, the number of the collecting system and the time information are received from the collecting system, the central system 200 records the received information (S240, S250).

The central system 200 determines when the motor vehicle enters, moves or leaves referring to the number of the collecting system from the received information (S260). At this time, if it is determined that the motor vehicle enter or moves, the central system 200 records the information transmitted from the collecting system cumulatively.

Meanwhile, if it is determined that the motor vehicle leaves referring to the number of the collecting system from the received information, the central system 200 extracts the vehicle information, the number of the collecting system and the time information of the telephone number recorded cumulatively (S270). The central system 200 calculates the charges based on the extracted information. At this time, when the toll of the expressway is calculated, the charges of each area based on the collecting systems are totaled. Meanwhile, in the case of a parking lot, the parking charge is calculated based on the entrance time information and the departure time information.

If the amount charged to the user is calculated, the central system 200 sends the charges to the payment system 100 (S290). The payment is settled normally by the payment system (S300), the central system 200 notifies the information of the settlement process result through the mobile phone of the user (S310). The result information is transmitted, for example, through the SMS.

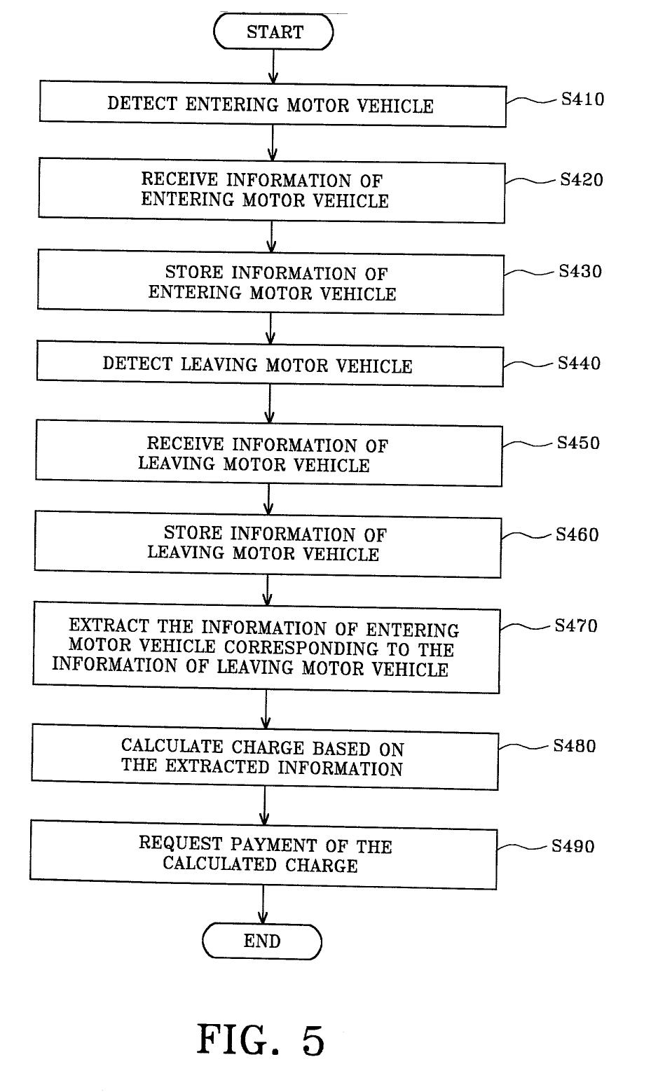

FIG. 5 illustrates a flow chart showing a charge collecting method for motor vehicles in a parking lot in detail according to another embodiment of the present invention.

In the case of a parking lot, the entering motor vehicle is detected (S410), and the information of the entering motor vehicle is received through collecting system (S420). At this time, the information of the motor vehicle received from the motor vehicle includes the telephone number of the mobile phone, the number of the motor vehicle and the kind of the motor vehicle. The information of the motor vehicle received from the entering motor vehicle is transmitted to and stored in the central system (S430). The central system stores also the time of receiving the information when the received information of the motor vehicle is stored.

When the motor vehicle leaving the parking lot is detected (S440), the information of the departing motor vehicle is received through the collecting system (S450). At this time, the information of the motor vehicle received from the motor vehicle includes the telephone number of the mobile phone, the number of the motor vehicle and the kind of the motor vehicle. The information of the motor vehicle received from the departing motor vehicle is transmitted to and stored in the central system (S460). The central system stores also the time of receiving the information when the received information of the motor vehicle is stored.

Meanwhile, if it is determined that the motor vehicle leaves the parking lot, the central system 200 extracts the information of the entering motor vehicle corresponding to the information of the departing motor vehicle (S470). That is, the information of the entering motor vehicle that corresponds to the telephone number of the mobile phone and the number of the motor vehicle included in the information of the departing motor vehicle.

If the information of the motor vehicle is extracted, the central system 200 calculates the parking charge based on the extracted information of the motor vehicle (S480). The parking charge is a value of the difference between the time receiving the information of the departing motor vehicle and the time receiving the information of the entering motor vehicle.

Finally, when the parking charge is calculated, the central system 200 requests the settlement of the payment through the payment system 100. At this time, for example, in the case where the parking charge is included in a bill of the mobile terminal, the central system sends a request of the settlement of the payment to the payment system of the mobile communication service company.

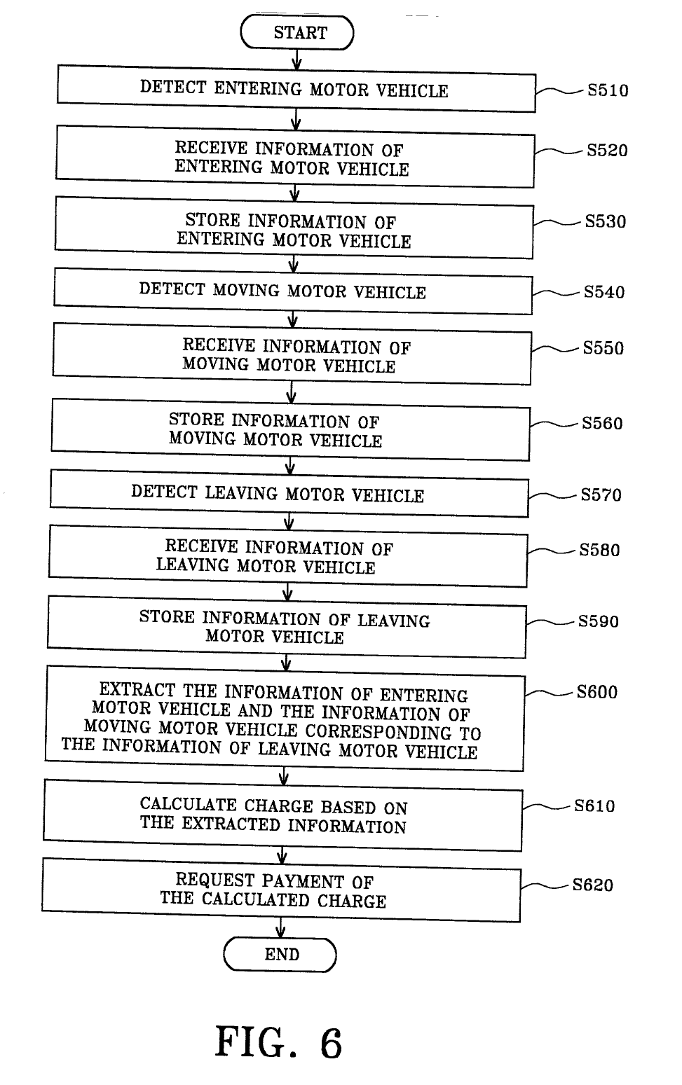

FIG. 6 illustrates a flow chart showing a fee collecting method for motor vehicles on the expressway in detail according to a further embodiment of the present invention.

In case of a tollgate on the expressway, the motor vehicle entering the tollgate is detected (S510), and the information of the entering motor vehicle is received through the collecting system (S520). At this time, the information of the motor vehicle received from the motor vehicle includes the telephone number of the mobile phone, the number of the motor vehicle and the kind of motor vehicle. The information of the motor vehicle received from the entering motor vehicle is transmitted to and stored in the central system (S530). The central system stores also the time of receiving the information and an ID number of the collecting system receiving the information when the received information of the motor vehicle is stored.

Then when the motor vehicle moves to the next tollgate after passing the first tollgate of the expressway, the moving motor vehicle is detected (S540), and the information of the moving motor vehicle is received through the collecting system (S550). At this time, the information of the motor vehicle received from the moving motor vehicle includes the telephone number of the mobile phone, the number of the motor vehicle and the kind of motor vehicle. The information of the motor vehicle received from the moving motor vehicle is transmitted to and stored in the central system (S560). The central system 200 stores also the time of receiving the information and the ID number of the collecting system receiving the information when the received information of the motor vehicle is stored.

When the motor vehicle goes out through the tollgate of the expressway, the departing motor vehicle is detected (S570), and the central system receives the information of the departing motor vehicle through the collecting system (S580). At this time, the information of the motor vehicle received from the motor vehicle includes the telephone number of the mobile phone, the number of the motor vehicle and the kind of motor vehicle. The information of the motor vehicle received from the departing motor vehicle is transmitted to and stored in the central system (S590). The central system stores also the time of receiving the information and the ID number of the collecting system receiving the information when the received information of the motor vehicle is stored.

Meanwhile, if it is determined that the motor vehicle leaves the tollgate, the central system 200 extracts the information of the entering motor vehicle corresponding to the information of the departing motor vehicle (S600). That is, the information of the entering motor vehicle that corresponds to the telephone number of the mobile phone and the number of the motor vehicle included in the information of the departing motor vehicle.

If the information of the motor vehicle is extracted, the central system 200 generally calculates the toll based on the extracted information of the motor vehicle. At this time, the collecting system is identified referring the ID number stored when the information of the motor vehicle is received.

Finally, when the toll is calculated, the central system 200 sends a request of the settlement of the payment to the payment system 100. At this time, in the case where the toll is included in a bill of the mobile terminal, the central system sends a request of the settlement of the payment to the payment system of the mobile communication service company.

The prior arts have the following several problems. The driver must keep the entrance ticket or parking ticket received when the motor vehicle enters the expressway or the parking lot, without loss or any damage. Furthermore, the motor vehicle may be operated incorrectly due to the driver's motions when the driver receives the entrance ticket. Moreover, it takes a long time to receive the entrance ticket if there is a distance between the driver and the entrance ticket dispenser, thereby slowing traffic.

However, the present invention can automatically detect the entrance and departure of a motor vehicle and make charges through a mobile phone number mounted in the vehicle. Furthermore, the present invention can notify the driver of a process result of the charges of the motor vehicle through a mobile phone number mounted in the vehicle. Moreover, the present invention has a motor vehicle control device for transmitting the telephone number and the information of the motor vehicle, on which the charges are imposed, when the payment request signal is detected.

Additionally, the present invention can save resources because a secondhand mobile phone is used as a car phone by being connected with the motor vehicle control device.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A fee collecting system for motor vehicles, which detects the entrance and departure of motor vehicles and makes charges, the system comprising:
a plurality of collecting systems transmitting payment request signals to a detected motor vehicle when the motor vehicle is detected, each collecting system outputting response signals of the payment request, an ID number and time information when the response signal to the payment request is received from the motor vehicle;
a motor vehicle control device mounted in the motor vehicle, the motor vehicle control device transmitting a telephone number and response signal to the payment request with information of the motor vehicle when the payment request signal is detected from the collecting system; and
a central system receiving and recording the response signal of payment request, the ID number and the time information output from the collecting system, the central system calculating charges based on the recorded information when the motor vehicle goes out and requesting settlement of the payment

2. The system according to claim 1, wherein the system further comprising payment system settling the payment of the charges when the payment is requested from the central system and notifying it to the central system.

3. The system according to claim 1, wherein the central system determines whether the motor vehicle enters or leaves based on the ID number.

4. The system according to claim 1, wherein the central system adds all charges in all areas among the collecting systems if the collecting systems are installed in the areas where a motor vehicle is traveling.

5. The system according to claim 1, wherein the central system calculates the charges based on a period of time between an entrance time and a departure time of the motor vehicle if the collecting systems are installed in a parking area for parking the motor vehicle during a prescribed period of time.

6. The system according to claim 1, wherein the collecting system has a payment request signal sending/receiving part.

7. The system according to claim 1, wherein the motor vehicle control device includes:
a payment request signal sending/receiving part for receiving payment request signals from the collecting system and sending response signals to payment request;
a motor vehicle information storage for storing a user's mobile phone number, the number of motor vehicle and the kind of motor vehicle;
a controller extracting the mobile phone number, the number of motor vehicle and the kind of motor vehicle stored in the motor vehicle information storage when the payment requesting signal is detected from the payment request signal sending/receiving part and transmitting them to the payment request signal sending/receiving part; and
an interface for transmitting data and control signals between the controller and the mobile terminal to the controller and the mobile terminal according to a designated protocol.

8. The system according to claim 7, wherein the motor vehicle control device includes:
a display for displaying the status of a payment request and a process result on a screen; and
a sound output part for outputting the status of the payment request and the process result in sound.

9. The system according to claim 7, wherein the motor vehicle control device includes:
a key input part for inputting an order to refer to the status of the payment request and the process result; and
a sound input part for inputting a voice order to refer to the status of the payment request and the process result.

10. A motor vehicle control device comprising:
a payment request signal sending/receiving part for receiving payment request signals and sending response signals to payment requests;
a motor vehicle information storage for storing a mobile phone number, the license number of motor vehicle and the kind of motor vehicle of a user;
a controller extracting the mobile phone number, the number of motor vehicle and the kind of motor vehicle stored in the motor vehicle information storage when the payment request signal is detected from the payment request signal sending/receiving part and transmitting them to the payment requesting signal sending/receiving part; and
an interface for transmitting data and control signals between the controller and the mobile terminal to the controller and the mobile terminal according to a designated protocol.

11. The motor vehicle control device according to claim 10, further comprising:
a display for displaying the status of a payment request and a process result on a screen; and
a sound output part for outputting the status of a payment request and the process result in sound.

12. The motor vehicle control device according to claim 10, further comprising:
a key input part for inputting an order to refer the status of the payment request and the process result; and
a sound input part for inputting a voice order to refer to the status of the payment request and the process result.

13. A fee collecting method for motor vehicles, the method comprising the steps of:
receiving the information of an entering motor vehicle from the entering motor vehicle when the entering motor vehicle is detected;
storing the information of the entering motor vehicle received from the entering motor vehicle;
receiving the information of a departing motor vehicle from the going-out motor vehicle when the departing motor vehicle is detected;
storing the information of the departing motor vehicle received from the departing motor vehicle;
extracting the information of the entering motor vehicle corresponding to the information of the departing motor vehicle when the storing of the information of the departing motor vehicle is completed;
calculating a charge based on the information of the entering motor vehicle and the information of the departing motor vehicle; and
requesting a payment of the charge calculated in the calculating step.

14. The method according to claim 13, wherein the information of the entering motor vehicle received in the step of receiving the information of the entering motor vehicle includes a telephone number of a mobile terminal, the license number of the motor vehicle and the kind of the motor vehicle.

15. The method according to claim 13, wherein the step of storing the information of the entering motor vehicle includes a step of storing the time of receiving the information of the entering motor vehicle.

16. The method according to claim 13, wherein in the step of receiving the information of the going-out motor vehicle, the information of the going-out motor vehicle includes a telephone number of a mobile terminal, the license number of the motor vehicle and the kind of the motor vehicle.

17. The method according to claim 13, wherein the step of storing the information of the departing motor vehicle includes a step of storing the time of receiving the information of the departing motor vehicle.

18. The method according to claim 13, wherein the step of calculating the charge includes a step of calculating a value, from the time of receiving the information of the entering motor vehicle to the time receiving the information of the departing motor vehicle, as the charge.

19. The method according to claim 13, wherein the step of requesting the payment includes a sending a request of the payment to the mobile communication service company of the telephone number of the mobile terminal included in the information of the motor vehicle.

20. A charge collecting method for motor vehicles, the method comprising the steps of:
receiving the information of an entering motor vehicle from the entering motor vehicle when the entering motor vehicle is detected;
storing the information of the entering motor vehicle received from the entering motor vehicle;
receiving the information of a moving motor vehicle from the moving motor vehicle when the moving motor vehicle is detected;
storing the information of the moving motor vehicle received from the moving motor vehicle;
receiving information of a departing motor vehicle from the departing motor vehicle when the departing motor vehicle is detected;
storing the information of the departing motor vehicle received from the departing motor vehicle;
extracting the information of the entering motor vehicle and the moving motor vehicle corresponding to the information of the departing motor vehicle when the storing of the information of the departing motor vehicle is completed;
calculating a charge based on the information of the entering motor vehicle, the information of the departing motor vehicle and the information of the moving motor vehicle; and
requesting a payment of the charge calculated in the calculating step.

21. The method according to claim 20, wherein in the information of the entering motor vehicle received in the step of receiving the information of the entering motor vehicle, the information of the entering motor vehicle includes a telephone number of a mobile terminal, the license number of the motor vehicle and the kind of the motor vehicle.

22. The method according to claim 20, wherein the step of storing the information of the entering motor vehicle includes a step of storing an identifier of the device detecting the entering motor vehicle and the time of receiving the information of the entering motor vehicle.

23. The method according to claim 20, wherein in the step of receiving the information of the moving motor vehicle, the information of the moving motor vehicle includes a telephone number of a mobile terminal, the license number of the motor vehicle and the kind of the motor vehicle.

24. The method according to claim 20, wherein the step of storing the information of the moving motor vehicle includes a step of an identifier of the device detecting the moving motor vehicle and time receiving the information of the moving motor vehicle.

25. The method according to claim 20, wherein in the step of receiving the information of the departing motor vehicle, the information of the departing motor vehicle includes a telephone number of a mobile terminal, the license number of the motor vehicle and the kind of motor vehicle.

26. The method according to claim 20, wherein the step of storing the information of the departing motor vehicle includes a step of an identifier of a device detecting the departing motor vehicle and time receiving the information of the departing motor vehicle.

27. The method according to claim 20, wherein the step of calculating the charge includes a step of calculating a value between areas of the identifiers of the devices, which detects the motor vehicle, based on the information of the entering motor vehicle, the information of the moving motor vehicle and the information of the departing motor vehicle as the charge.

28. The method according to claim 20, wherein the step of requesting the payment includes a step of sending a request of the payment to the mobile communication service company of the telephone number of the mobile terminal included in the information of the motor vehicle.
